(19) United States
(12) Patent Application Publication
(10) Pub. No.: US 2021/0191547 A1
(43) Pub. Date: Jun. 24, 2021

(54) Drive Circuit and Drive Method of Touch Display Panel, and Touch Display Apparatus

(71) Applicants: Chongqing BOE Optoelectronics Technology Co., Ltd., Chongqing (CN); BOE Technology Group Co., Ltd., Beijing (CN)

(72) Inventors: Yihjen HSU, Beijing (CN); Peng QIN, Beijing (CN); Zhongshan WU, Beijing (CN); Jiandong GUO, Beijing (CN)

(21) Appl. No.: 16/899,600

(22) Filed: Jun. 12, 2020

(30) Foreign Application Priority Data
Dec. 19, 2019 (CN) 201911320589.2

(51) Int. Cl. G06F 3/041

(52) U.S. Cl. CPC G06F 3/0412; G06F 3/04182; G06F 3/04184

(57) ABSTRACT

A drive circuit and a drive method of a touch display panel, and a touch display apparatus are provided. The drive circuit includes a system unit and a timing controller. The system unit is configured to send a touch enabled signal to the timing controller when a touch function is enabled. The timing controller is configured to receive the touch enabled signal from the system unit, and insert a test pattern between display image frames in every preset time interval, wherein touch panel noise generated by the test pattern is lower than a preset noise threshold.

### CROSS-REFERENCE TO RELATED APPLICATION

The present application claims the priority of Chinese patent application No. 2019113205892 filed to CNIPA on Dec. 19, 2019, the content of which is hereby incorporated by reference.

### TECHNICAL FIELD

Embodiments of the present disclosure relate to, but are not limited to, the technical field of display, in particular, a drive circuit and a drive method of a touch display panel, and a touch display apparatus.

### BACKGROUND

In addition to a direct touch operation with fingers, an active pen may be used to replace fingers for a touch input operation on a capacitive touch screen. The principle of the active pen is that the capacitive touch screen receives a signal sent by the active pen through a coupling capacitor.

However, due to continuous pursuit of ultra-high precision and ultra-thinness in the touch technology, a distance between a touch sensing device and a liquid crystal display (LCD) drive device decreases after thinning, resulting in a closer coupling between the touch sensing device and the LCD drive device, causing serious noise interference from the LCD to the touch screen, thus affects accuracy of touch event detection of the touch screen and specification determination of the active pen.

### SUMMARY

The following is a summary of subject matter described in detail herein. The summary is not intended to limit a protection scope of the claims.

An embodiment of the disclosure provides a drive circuit of a touch display panel, which includes a system unit and a timing controller. The system unit is configured to send a touch enabled signal to the timing controller when a touch function is enabled. The timing controller is configured to receive the touch enabled signal from the system unit, insert a test pattern between display image frames in every preset time interval, wherein touch panel noise generated by the test pattern is lower than a preset noise threshold.

In some possible implementations, the drive circuit of the touch display panel further includes a control unit and a touch drive unit, wherein the system unit is further configured to send a touch enabled signal to the control unit when the touch function is enabled; the control unit is configured to receive the touch enabled signal of the system unit, generate a touch synchronization signal according to the touch enabled signal, and output the touch synchronization signal to the touch drive unit; the touch drive unit is configured to scan touch rows of the touch display panel according to the touch synchronization signal in display of an image frame.

In some possible implementations, the drive circuit of the touch display panel further includes a gate drive unit, wherein the timing controller is further configured to output gate drive signals to the gate drive unit; the gate drive unit is configured to generate gate control signals according to the gate drive signals and output the gate control signals to gate lines of the touch display panel to progressively scan the gate lines.

In some possible implementations, the system unit is further configured to divide a time period in which the touch display panel displays each image frame into N control periods, herein, each control period includes a display period and a touch period that are sequentially set, and N is an integer greater than or equal to 1. In the time period when the touch display panel displays each image frame, the gate drive unit scans a plurality of gate lines of the touch display panel in sequence in N display periods, and the touch drive unit scans a plurality of touch rows of the touch display panel in sequence in each touch period.

In some possible implementations, inserting the test pattern between display image frames in every preset time interval includes: inserting one said test pattern at every other display image frame or more display image frames; or, inserting one said test pattern in one or more touch periods in display of an image frame in every preset time interval.

In some possible implementations, the system unit is configured to send the touch enabled signal to the timing controller each time a touch period is entered; or, when a touch function is turned on, send the touch enabled signal to the timing controller.

An embodiment of the disclosure further provides a touch display apparatus, which includes a touch display panel and a drive circuit of the touch display panel as described above.

In some possible implementations, the touch display panel is a Single Layer On Cell (SLOC) touch display panel, and a touch mode of the touch display panel is through an active pen.

An embodiment of the disclosure further provides a drive method of the touch display panel, wherein the drive circuit of the touch display panel includes a system unit and a timing controller, and the drive method includes: when a touch function is enabled, the system unit sends a touch enabled signal to the timing controller; the timing controller receives the touch enabled signal from the system unit, and inserts a test pattern between display image frames in every preset time interval, herein, touch panel noise generated by the test pattern is lower than a preset noise threshold.

In some possible implementations, the drive circuit of the touch display panel further includes a gate drive unit, a control unit and a touch drive unit, and the drive method further includes: the system unit divides a time period in which the touch display panel displays each image frame into N control periods, each control period includes a display period and a touch period which are sequentially set, and N is an integer greater than or equal to 1; the timing controller outputs gate drive signals to the gate drive unit when a display period starts; the gate drive unit generates gate control signals according to the gate drive signals and outputs the gate control signals to gate lines in a plurality of display periods in display of an image frame to progressively scan the gate lines; the timing controller inserts the test pattern between display image frames in every preset time interval when a touch period starts; the control unit generates a touch synchronization signal according to the touch enabled signal and outputs the touch synchronization signal to the touch drive unit when the touch period starts; the touch drive unit scans the touch rows of the touch display panel according to the touch synchronization signal in each touch period in display of the image frame.

In some possible implementations, inserting the test pattern between display image frames in every preset time interval includes: inserting one said test pattern every other display image frame or more display image frames; or, inserting one said test pattern in one or more touch periods in display of an image frame in every preset time interval.

According to the drive circuit, the drive method of the touch display panel and the touch display apparatus provided by the embodiments of the disclosure, by inserting a test pattern, of which generated touch panel noise is lower than a preset noise threshold, between display image frames in every preset time interval, which cannot be perceived by a user due to persistence of vision, noise of the touch display panel is reduced, accuracy of touch event detection of the touch display is improved, and thus specification determination of an active pen is improved.

Other aspects will be understood upon reading and understanding brief description of accompanying drawings and embodiments of the present disclosure.

### BRIEF DESCRIPTION OF DRAWINGS

Accompanying drawings are used to provide further understanding of technical solutions of the present disclosure and form a part of the description, and explain technical solutions of the present disclosure together with embodiments of the present disclosure, which do not constitute a limitation on the technical solutions of the present disclosure.

FIG. 1 is a first schematic diagram of structure of a drive circuit of a touch display panel according to an embodiment of the present disclosure.

FIG. 2 is a second schematic diagram of structure of a drive circuit of a touch display panel according to an embodiment of the present disclosure.

FIG. 3 is a third schematic diagram of structure of a drive circuit of a touch display panel according to an embodiment of the present disclosure.

FIG. 4 is a schematic diagram of division of time periods for displaying an image frame according to an embodiment of the present disclosure.

FIG. 5 is a schematic diagram of structure of a touch display panel according to an embodiment of the disclosure.

FIG. 6 is a schematic diagram of a corresponding relationship between gate lines and touch rows of a touch display panel according to an embodiment of the disclosure.

FIG. 7 is a working mode diagram of a drive circuit of a touch display panel according to an embodiment of the present disclosure.

FIG. 8 is a schematic flowchart of a drive method of a touch display panel according to an embodiment of the disclosure.

FIG. 9 is a signal waveform diagram of a drive method of a touch display panel according to an embodiment of the disclosure.

Description of reference signs of the accompany drawings:

| | | |
|---|---|---|
| 10 - system unit | 20 - timing controller | 30 - control unit |
| 40 - touch drive unit | 50 - gate drive unit | 60 - array substrate |
| 70 - color filter substrate | 80 - touch sensor layer | 90 - liquid crystal layer |

### DETAILED DESCRIPTION

To make objects, technical solutions and advantages of the present disclosure more clear, embodiments of the present disclosure will be described in detail below with reference to accompanying drawings. Without conflict, embodiments in the present disclosure and features in the embodiments may be combined with each other arbitrarily.

Unless otherwise defined, technical terms or scientific terms used in the embodiments of the disclosure shall have the general meanings understood by those with general skills in the field to which the disclosure pertains. The words “first”, “second” and the like used in the embodiments of the present disclosure do not indicate any order, quantity or importance, but are only used to distinguish different components. Similar words such as “including” or “comprising” mean that elements or articles preceding the word cover elements or articles listed after the word and their equivalents, and do not exclude other elements or articles.

Those of ordinary skill in the art may understand that transistors used in embodiments of the present disclosure may be thin film transistors or field effect transistors or other devices with the same characteristics. The thin film transistor used in the embodiments of the present disclosure may be an oxide semiconductor transistor. Since a source and a drain of the transistor used herein are symmetrical, the source and the drain may be interchanged. In the embodiments of the present disclosure, one of two electrodes is referred to as a first electrode and the other electrode is referred to as a second electrode in order to distinguish the two electrodes of the transistor except the gate. The first electrode may be a source or a drain, and the second electrode may be a drain or a source.

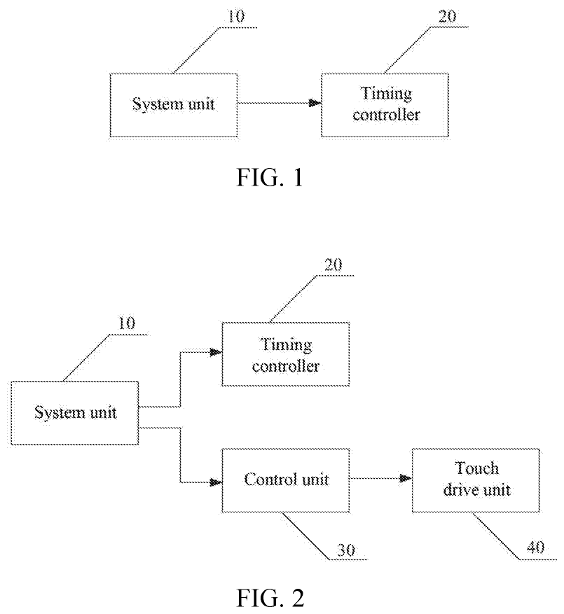

An embodiment of the present disclosure provides a drive circuit of a touch display panel. FIG. 1 is a schematic diagram of structure of the drive circuit of the touch display panel according to the embodiment of the present disclosure. As shown in FIG. 1, the drive circuit of the touch display panel provided by the embodiment of the present disclosure includes a system unit 10 and a timing controller 20.

The system unit 10 is configured to send a touch enabled signal to the timing controller 20 when a touch function is enabled; the timing controller 20 is configured to receive the touch enabled signal from the system unit 10, insert a test pattern between display image frames in every preset time interval, herein, touch panel noise generated by the inserted test pattern is lower than a preset noise threshold.

There are many noise interference factors in noise interference from a liquid crystal display to a touch screen. For example, the noise interference factors may include power of a power supply of a display panel, a display panel load, display panel material, etc. Among these noise interference factors, a display pattern of the display panel has greater noise interference to the touch screen. Due to different modes of level change of pixel arrays under different display patterns, different electromagnetic fields will be generated, which will generate noises with significantly different interference degrees to the touch screen. In the drive circuit of the touch display panel according to the embodiment of the disclosure, by inserting a test pattern, of which generated touch panel noise is lower than a preset noise threshold, between display image frames in every preset time interval, which cannot be perceived by a user due to persistence of vision, accuracy of touch event detection of the touch screen is improved, and thus specification determination of an active pen is improved.

In an exemplary embodiment, the timing controller 20 is further configured to store one or more test patterns in advance. The touch panel noise generated by the one or more test patterns is obtained by measurement in advance.

In an exemplary embodiment, as shown in FIG. 2, the drive circuit further includes a control unit 30 and a touch drive unit 40. Herein, the system unit 10 is further configured to send a touch enabled signal to the control unit 30 when a touch function is enabled, the control unit 30 is configured to receive the touch enabled signal from the system unit 10, generate a touch synchronization signal according to the touch enabled signal, and output the touch synchronization signal to the touch drive unit 40, the touch drive unit 40 is configured to scan touch rows of the touch display panel according to the touch synchronization signal in display of an image frame.

In an exemplary embodiment, the control unit 30 may be a microcontroller unit (MCU); the touch drive unit 40 may be a touch IC.

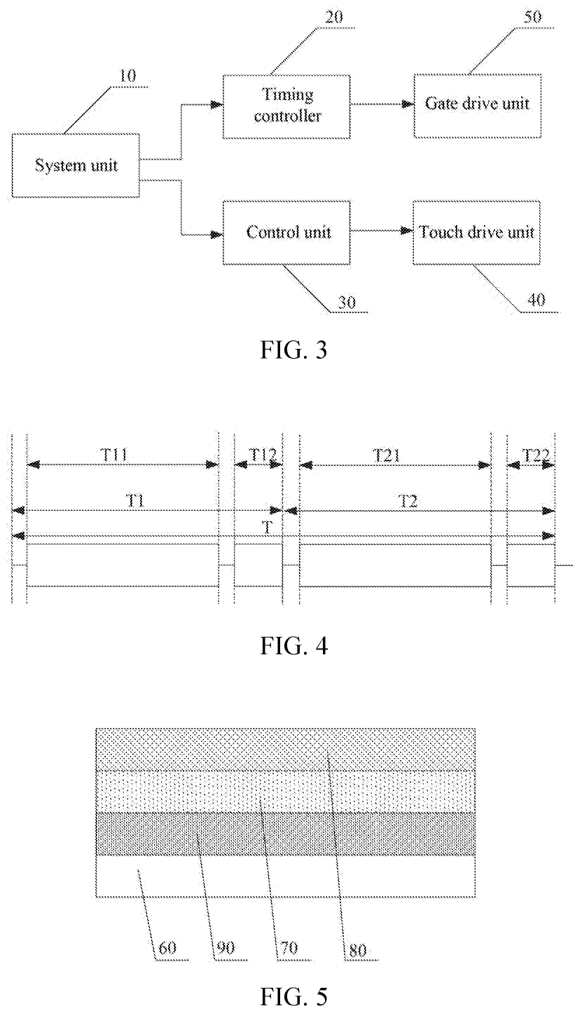

In an exemplary embodiment, as shown in FIG. 3, the drive circuit of the touch display panel further includes a gate drive unit 50. The timing controller 20 is further configured to output gate drive signals to the gate drive unit 50. The gate drive unit 50 is configured to generate gate control signals according to the gate drive signals and output the gate control signals to gate lines to progressively scan the gate lines.

In an exemplary embodiment, the gate drive unit 50 may be a Gate IC or a Gate Driver on Array (GOA) circuit.

In an exemplary embodiment, the system unit 10 divides a time period in which the touch display panel displays each image frame into N control periods, each control period includes a display period and a touch period that are sequentially set, and N is an integer greater than or equal to 1.

In an exemplary embodiment, the system unit 10 may send, at beginning of each display period, a first notification to the timing controller 20 to notify the timing controller 20 of start of the display period, and send, at beginning of a touch period, a second notification to the timing controller 20 and the control unit 30 to notify the timing controller 20 and the control unit 30 of start of the touch period.

In another exemplary embodiment, the system unit 10 may send a first notification to the timing controller 20 to notify the timing controller 20 of start of a display period when a display function is turned on, and send a second notification to the timing controller 20 and the control unit 30 to notify the timing controller 20 and the control unit 30 of start of a touch period when a touch function is turned on (e.g., an active pen is turned on). At this time, the timing controller 20 and the control unit 30 may calculate, according to a preset rule, time corresponding to a subsequent display period and touch period from a moment when the display period starts and a moment when the touch period starts, respectively. The timing controller 20 only needs to insert a test pattern between display image frames in every preset time interval during a period of time from a moment when the active pen is turned on to a moment when the active pen is turned off. This method reduces transmission times of control signals and further reduces power consumption of the device.

In an exemplary embodiment, during a time period when the touch display panel displays each image frame, the gate drive unit 50 sequentially scans a plurality of gate lines of the touch display panel in N display periods, and the touch drive unit 40 sequentially scans a plurality of touch rows of the touch display panel in each touch period.

In an exemplary embodiment, when N=1, a report rate of the touch drive unit 40 is equal to a gate scanning frequency of the touch display panel. The touch drive unit 40 is configured to scan the touch rows of the touch display panel once in display of an image frame according to the touch synchronization signal. In this case, a time period T for displaying each image frame is divided into a display period T11 and a touch period T12, a plurality of gate lines are sequentially scanned in the display period T11, and a plurality of touch rows of the touch display panel are sequentially scanned in the touch period T12. At this time, time for touch scanning in the time of one frame is limited, so sensitivity and the report rate are low, and touch performance of the touch display panel is poor.

In another exemplary embodiment, when N>1, the report rate of the touch drive unit 40 is greater than the gate scanning frequency of the touch display panel. The touch drive unit 40 is configured to scan touch rows of the touch display panel for a plurality of times according to the touch synchronization signal in display of an image frame.

In an exemplary embodiment, when N=2, the report rate of the touch drive unit 40 is 2 times of the gate scanning frequency of the touch display panel. The touch drive unit 40 is configured to scan the touch rows of the touch display panel twice according to the touch synchronization signal in display of an image frame. As shown in FIG. 4, a time period T for displaying each image frame is divided into a first control period T1 and a second control period T2. The first control period includes a first display period T11 and a first touch period T12, and the second control period T2 includes a second display period T21 and a second touch period T22. A plurality of gate lines are sequentially scanned in the first display period T11 and the second display period T21. During the first touch period T12, a plurality of touch rows of the touch display panel are scanned in sequence, and during the second touch period T22, the plurality of touch rows of the touch display panel are scanned in sequence. At this time, two touch periods are set in a period of one frame, and two touch scans are completed, thereby improving the sensitivity, the report rate and the touch performance of the touch display panel.

In an exemplary embodiment, inserting a test pattern between display image frames in every preset time interval includes: inserting one test pattern every other display image frame or more display image frames; or, inserting one test pattern in one or more touch periods in display of an image frame in every preset time interval.

As an example, the timing controller 20 may insert one test pattern in the first touch period T12, or one test pattern in the second touch period T22, or one test pattern in both the first touch period T12 and the second touch period T22. When inserting a test pattern in the first touch period T12, the timing controller 20 needs to insert an original display image frame before start of the second display period T21, so as not to damage an original display function.

In an exemplary embodiment, the control unit 30 is further configured to output a Touch Report to the system unit 10. The system unit 10 is configured to transmit coordinate information in the touch report to the timing controller 20 through an Enhanced Device Protocol (EDP), and the timing controller 20 is further configured to decode the coordinate information in the touch report and transmit the decoded coordinate information to the touch display panel.

An embodiment of the disclosure further provides a touch display apparatus, the touch display apparatus includes a touch display panel and a drive circuit of the touch display panel. Herein, the drive circuit of the touch display panel may adopt the drive circuit of the touch display panel of the above embodiment, which is not repeatedly described here.

The drive circuit of the touch display panel may be used for driving the touch display panel. FIG. 5 is a schematic diagram of structure of a touch display panel. As shown in FIG. 5, in an exemplary embodiment, the touch display panel includes an array substrate 60 and a color filter substrate 70 which are oppositely arranged, and a touch sensor layer 80 is arranged on a side, which is away from the array substrate 60, of the color filter substrate 70. A liquid crystal layer 90 is arranged between the array substrate 60 and the color filter substrate 70. The array substrate 60 includes a substrate, and a plurality of gate lines and a plurality of data lines which are located near to one side of the color filter substrate 70 on the substrate, and the plurality of gate lines and the plurality of data lines are arranged crosswise. The touch sensor layer 80 includes a plurality of touch rows, each touch row including a plurality of sensor patterns. In an exemplary embodiment, the touch drive unit 40 scans touch rows in a row scanning manner. In an exemplary embodiment, for example, a shape of the touch rows may be a fishbone. In an exemplary embodiment, touch rows and gate lines extend in the same direction, herein, the substrate, gate lines, data lines, and sensor patterns are not shown in FIG. 5.

In an exemplary embodiment, the touch display panel may be an On Cell touch display panel. As an example, the touch display panel may be a Single Layer On Cell (SLOC) touch display panel, and a touch mode of the touch display panel may be touch the touch display panel with an active pen. SLOC adopts a touch sensor layer fabricated directly on a Color Filter (CF) substrate relative to a One Glass Solution (OGS), thus making the display apparatus lighter.

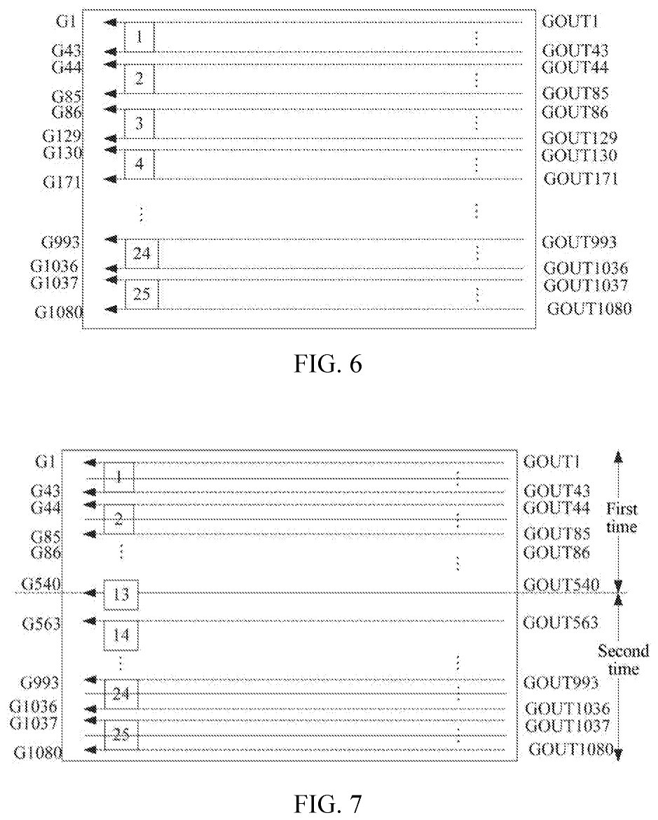

FIG. 6 is a corresponding relationship diagram of gate lines and touch rows of a touch display panel according to an embodiment of the disclosure. As shown in FIG. 6, gate lines and touch rows are arranged correspondingly, each touch row is arranged correspondingly to at least one gate line, and in an exemplary embodiment, each touch row is arranged correspondingly to a plurality of gate lines. For example, taking a currently mass-produced 15.6-inch Full High Definition (FHD) High Advanced Super Dimension Switch (HADS) SLOC touch display panel as an example, the touch display panel includes 1080 rows of gate lines, and the 1080 rows of gate lines include gate lines G1, G2, . . . , and G1080, then the 1080 rows of gate lines are respectively loaded with gate control signals GOUT1, GOUT2, . . . , GOUT1080; the touch display panel includes 25 rows of touch rows, and the 25 rows of touch rows includes touch row 1, touch row 2, . . . , and touch row 25 (numbers shown in left boxes in FIG. 6 indicate quantities of touch rows). Herein, different touch rows may correspond to the same quantity of gate lines or different quantities of gate lines, and in the embodiment of the present disclosure, different touch rows correspond to different quantities of gate lines. For example, touch row 1 corresponds to gate lines G1 to G43, touch row 2 corresponds to gate lines G44 to G85, touch row 3 corresponds to gate lines G86 to G129, . . . , and touch row 25 corresponds to gate lines G1037 to G1080. In the embodiment of the present disclosure, a corresponding arrangement of a touch row and a gate line refers to a corresponding arrangement of the touch row and the gate line in spatial positions. For example, as shown in FIGS. 5 and 6, the touch row is located directly above the corresponding gate line. In other words, an orthographic projection of the touch row on the substrate coincides with an orthographic projection of the corresponding gate line on the substrate.

As shown in FIG. 7, it is assumed that in an implementation, a gate scanning frequency of the touch display panel is 60 Hz and a report rate of the touch drive unit is 120 Hz. In a process of displaying an image frame, when the gate line of the touch display panel is scanned once, the touch row is scanned twice. For example, the gate drive unit 50 scans from the first row of gate line G1 to the 540th row of gate line G540 which corresponds to the 13th row of touch rows in spatial positions. At this time, the touch drive unit completes a first scan of the 25 rows of touch rows (a first time in FIG. 7 indicates a range of gate lines scanned when the first scan of the 25 rows of touch rows is completed, herein, the range of scanned gate lines includes the first row of gate line G1 to the 540th row of gate line G540). The gate drive unit 50 scans from the 541st row of gate line G541 to the 1080th row of gate line G1080, at this time, the touch drive unit completes a second scan of the 25 rows of touch rows (a second time in FIG. 7 indicates a range of the gate lines scanned when the second scan of the 25 rows of touch rows is completed, herein, the range of scanned gate line includes the 541st row of gate line G541 to the 1080th row of gate line G1080).

In the touch display apparatus according to the embodiment of the disclosure, by inserting a test pattern, of which generated touch panel noise is lower than a preset noise threshold, between display image frames in every preset time interval, noise of the touch display panel is reduced, accuracy of touch event detection of the touch display panel is improved, and thus specification determination of the active pen is improved.

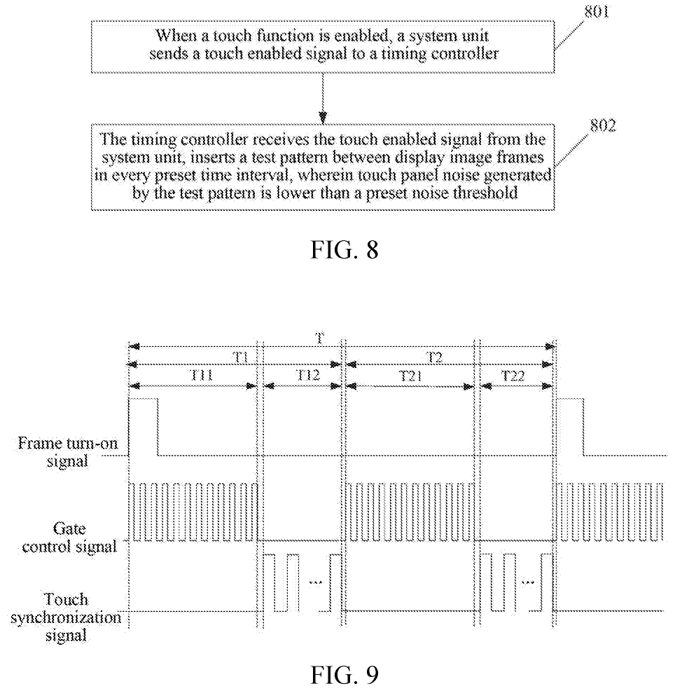

An embodiment of the present disclosure further provides a drive method of the touch display panel, as shown in FIG. 8, the derive method includes acts 801 to 802.

Act 801 includes: when a touch function is enabled, a system unit sends a touch enabled signal to a timing controller.

In an exemplary embodiment, when the touch function is enabled, sending, by the system unit, a touch enabled signal to the timing controller includes: the system unit sends the touch enabled signal to the timing controller each time when a touch period is entered; or, when a touch function is turned on (e.g., an active pen is turned on), the system unit sends the touch enabled signal to the timing controller.

Act 802 includes: the timing controller receives the touch enabled signal from the system unit, inserts a test pattern between display image frames in every preset time interval, herein, touch panel noise generated by the inserted test pattern is lower than a preset noise threshold.

In an exemplary embodiment, the drive method further includes:

the system unit divides a time period in which the touch display panel displays each image frame into N control periods, each control period includes a display period and a touch period which are sequentially set, and N is an integer greater than or equal to 1;

the timing controller outputs gate drive signals to a gate drive unit when a display period starts; the gate drive unit generates gate control signals according to the gate drive signals and outputs the gate control signals to gate lines in a plurality of display periods in display of an image frame to progressively scan the gate lines; the timing controller inserts the test pattern between display image frames in every preset time interval when a touch period starts;

when a touch period starts, the control unit generates a touch synchronization signal according to the touch enabled signal and outputs the touch synchronization signal to a touch drive unit; the touch drive unit scans touch rows of the touch display panel according to the touch synchronization signal in each touch period in the display of the image frame.

In an exemplary embodiment, as shown in FIG. 4, the system unit divides a time period T for displaying each image frame into a first control period T1 and a second control period T2, the first control period T1 includes a first display period T11 and a first touch period T12, the second control period T2 includes a second display period T21 and a second touch period T22, and a corresponding diagram of signal waveforms is shown in FIG. 9.

In an exemplary embodiment, inserting a test pattern between display image frames in every preset time interval includes: inserting one test pattern every other display image frame or more display image frames; or, inserting one test pattern in one or more touch periods in display of an image frame in every preset time interval.

In the drive method of the touch display panel according to the embodiment of the disclosure, by inserting a test pattern, of which generated touch panel noise is lower than a preset noise threshold, between display image frames in every preset time interval, noise of the touch display panel is reduced, accuracy of touch event detection of the touch display panel is improved, and thus specification determination of the active pen is improved.

In the description of the embodiments of the present disclosure, orientation or position relationships indicated by terms “intermediate”, “upper”, “lower”, “front”, “rear”, “vertical”, “horizontal”, “top”, “bottom”, “inside”, “outside” and the like are based on the orientation or position relationships shown in the accompany drawings, which are only for ease of description of the present disclosure and simplification of the description, rather than indicating or implying that a referred apparatus or element must have a specific orientation, or must be constructed and operated in a particular orientation, and therefore cannot be construed as a limitation on the present disclosure.

In the description of the embodiments of present disclosure, unless otherwise clearly specified and defined, the terms “install”, “connect” and “link” should be broadly interpreted, for example, it may be connected fixedly or connected detachably, or integrated, it may be a mechanical connection or an electrical connection, it may be directly connected, or may be indirectly connected through an intermediate medium, it may be an internal connection between two elements. Those of ordinary skilled in the art can understand the specific meanings of the above terms in the present disclosure according to specific situations.

Although the embodiments of the present disclosure are described in the above, the above described contents are only for better understanding, rather than restricting the present disclosure. A person skilled in the art may make any modifications and variations in forms and details of implementation without departing from the spirit and scope of the present disclosure. The protection scope of the present disclosure shall be determined by the scope as defined in the claims.

What we claim is:

1. A drive circuit of a touch display panel, comprising a system unit and a timing controller, wherein:
the system unit is configured to send a touch enabled signal to the timing controller when a touch function is enabled;
the timing controller is configured to receive the touch enabled signal from the system unit, insert a test pattern between display image frames in every preset time interval, wherein touch panel noise generated by the test pattern is lower than a preset noise threshold.

2. The drive circuit of the touch display panel according to claim 1, further comprising a control unit and a touch drive unit, wherein
the system unit is further configured to send the touch enabled signal to the control unit when the touch function is enabled;
the control unit is configured to receive the touch enabled signal from the system unit, generate a touch synchronization signal according to the touch enabled signal, and output the touch synchronization signal to the touch drive unit;
the touch drive unit is configured to scan touch rows of the touch display panel according to the touch synchronization signal in display of an image frame.

3. The drive circuit of the touch display panel according to claim 2, wherein the control unit is a microcontroller unit, and the touch drive unit is a touch IC.

4. The drive circuit of the touch display panel according to claim 2, further comprising: a gate drive unit, wherein
the timing controller is further configured to output gate drive signals to the gate drive unit;
the gate drive unit is configured to generate gate control signals according to the gate drive signals and output the gate control signals to gate lines of the touch display panel to progressively scan the gate lines.

5. The drive circuit of the touch display panel according to claim 4, wherein the gate drive unit is a Gate IC or a Gate Driver on Array (GOA) circuit.

6. The drive circuit of the touch display panel according to claim 4, wherein the system unit is further configured to divide a time period in which the touch display panel displays each image frame into N control periods, wherein each control period comprises a display period and a touch period that are sequentially set, and N is an integer greater than or equal to 1;
in the time period when the touch display panel displays each image frame, the gate drive unit scans a plurality of gate lines of the touch display panel in sequence in N display periods, and the touch drive unit scans a plurality of touch rows of the touch display panel in sequence in each touch period.

7. The drive circuit of the touch display panel according to claim 6, wherein the system unit is further configured to send a first notification to the timing controller at beginning of each of the N display periods, to notify the timing controller of start of each of the N display periods, and send a second notification to the timing controller and the control unit at beginning of a touch period, to notify the timing controller and the control unit of start of the touch period.

8. The drive circuit of the touch display panel according to claim 6, wherein the system unit is further configured to send a first notification to the timing controller to notify the timing controller of start of a display period when a display function is turned on, and send a second notification to the timing controller and the control unit to notify the timing controller and the control unit of start of a touch period when the touch function is turned on.

9. The drive circuit of the touch display panel according to claim 1, wherein inserting, by the timing controller, a test pattern between display image frames in every preset time interval, comprises: inserting one said test pattern every other display image frame or more display image frames; or, inserting one said test pattern in one or more touch periods in display of an image frame in every preset time interval.

10. A touch display apparatus comprising a touch display panel and a drive circuit of the touch display panel, wherein the drive circuit of the touch display panel comprises a system unit and a timing controller, wherein,
the system unit is configured to send a touch enabled signal to the timing controller when a touch function is enabled;
the timing controller is configured to receive the touch enabled signal from the system unit, insert a test pattern between display image frames in every preset time interval, wherein touch panel noise generated by the test pattern is lower than a preset noise threshold.

11. The touch display apparatus according to claim 10, wherein the drive circuit of the touch display panel further comprises a control unit and a touch drive unit;
the system unit is further configured to send the touch enabled signal to the control unit when the touch function is enabled;
the control unit is configured to receive the touch enabled signal from the system unit, generate a touch synchronization signal according to the touch enabled signal, and output the touch synchronization signal to the touch drive unit;
the touch drive unit is configured to scan touch rows of the touch display panel according to the touch synchronization signal in display of an image frame.

12. The touch display apparatus according to claim 11, wherein the control unit is a microcontroller unit and the touch drive unit is a touch IC.

13. The touch display apparatus according to claim 11, wherein the drive circuit of the touch display panel further comprises a gate drive unit;
the timing controller is further configured to output gate drive signals to the gate drive unit;
the gate drive unit is configured to generate gate control signals according to the gate drive signals and output the gate control signals to gate lines of the touch display panel to progressively scan the gate lines.

14. The touch display apparatus according to claim 13, wherein the system unit is further configured to divide a time period in which the touch display panel displays each image frame into N control periods, wherein each control period comprises a display period and a touch period that are sequentially set, and N is an integer greater than or equal to 1;
in the time period when the touch display panel displays each image frame, the gate drive unit scans a plurality of gate lines of the touch display panel in sequence in N display periods, and the touch drive unit scans a plurality of touch rows of the touch display panel in sequence in each touch period.

15. The touch display apparatus according to claim 14, wherein the system unit is further configured to send a first notification to the timing controller at beginning of each of the N display periods to notify the timing controller of start of each of the N display periods, and send a second notification to the timing controller and the control unit at beginning of a touch period to notify the timing controller and the control unit of start of the touch period.

16. The touch display apparatus according to claim 14, wherein the system unit is further configured to send a first notification to the timing controller to notify the timing controller of start of a display period when a display function is turned on, and send a second notification to the timing controller and the control unit to notify the timing controller and the control unit of start of a touch period when a touch function is turned on.

17. The touch display apparatus according to claim 10, wherein the touch display panel is a Single Layer On Cell (SLOC) touch display panel, and a touch mode of the touch display panel is through an active pen.

18. A drive method of a touch display panel, wherein a drive circuit of the touch display panel comprises a system unit and a timing controller, the drive method comprising:
when a touch function is enabled, sending, by the system unit, a touch enabled signal to the timing controller; and
receiving, by the timing controller, the touch enabled signal from the system unit, and inserting a test pattern between display image frames in every preset time interval, wherein touch panel noise generated by the test pattern is lower than a preset noise threshold.

19. The drive method of the touch display panel according to claim 18, wherein the drive circuit of the touch display panel further comprises a gate drive unit, a control unit and a touch drive unit, and the drive method further comprising:
dividing, by the system unit, a time period in which the touch display panel displays each image frame into N control periods, wherein each control period comprises a display period and a touch period which are sequentially set, and N is an integer greater than or equal to 1;
outputting, by the timing controller, gate drive signals to the gate drive unit when a display period starts;
generating, by the gate drive unit, gate control signals according to the gate drive signals and outputting the gate control signals to gate lines in a plurality of display periods in display of an image frame to progressively scan the gate lines;
inserting, by the timing controller, the test pattern between display image frames in every preset time interval when a touch period starts;
generating, by the control unit, a touch synchronization signal according to the touch enabled signal and outputting the touch synchronization signal to the touch drive unit when the touch period starts; and
scanning, by the touch drive unit, touch rows of the touch display panel according to the touch synchronization signal in each touch period in the display of the image frame.

20. The drive method of the touch display panel according to claim 18, wherein inserting a test pattern between display image frames in every preset time interval comprises:
inserting one said test pattern every other display image frame or more display image frames; or,
inserting one said test pattern in one or more touch periods in display of an image frame in every preset time interval.
